(19) United States
(12) Patent Application Publication
(10) Pub. No.: US 2025/0246765 A1
(43) Pub. Date: Jul. 31, 2025

(54) BATTERY PACK AND CONDUCTIVE MODULE COMPONENT

(71) Applicant: Yazaki Corporation, Tokyo (JP)

(72) Inventors: Katsunori Sato, Shizuoka (JP); Tatsuya Oga, Shizuoka (JP); Mariko Nakagawa, Shizuoka (JP); Masato Tanaka, Shizuoka (JP)

(73) Assignee: Yazaki Corporation, Tokyo (JP)

(21) Appl. No.: 19/016,141

(22) Filed: Jan. 10, 2025

(30) Foreign Application Priority Data
Jan. 30, 2024 (JP) 2024-012068

(51) Int. Cl. H01M 50/507; H01M 50/209; H01M 50/503; H01M 50/519; H01M 50/55

(52) U.S. Cl. CPC H01M 50/507; H01M 50/503; H01M 50/519; H01M 50/55; H01M 50/209

(57) ABSTRACT

A conductive module component includes an inter-cell bus bar, a total electrode bus bar, an inter-cell bus bar housing member which is assembled to an electrode terminal group and in which an inter-cell bus bar housing chamber for each inter-cell bus bar is provided, a common housing member which is assembled to an electrode terminal group and in which an inter-cell bus bar housing chamber for each inter-cell bus bar is provided, and a total electrode bus bar housing member which is assembled to the electrode terminal group and in which a total electrode bus bar housing chamber is formed.

### CROSS-REFERENCE TO RELATED APPLICATION(S)

The present application claims priority to and incorporates by reference the entire contents of Japanese Patent Application No. 2024-012068 filed in Japan on Jan. 30, 2024.

### BACKGROUND OF THE INVENTION

### 1. Field of the Invention

The present invention relates to a battery pack and a conductive module component.

### 2. Description of the Related Art

A battery module includes a plurality of battery cells arranged in a row, and a first electrode terminal group in which electrode terminals on one side of the plurality of battery cells are arranged in an arrangement direction and a second electrode terminal group in which electrode terminals on the other side of the plurality of battery cells are arranged in the arrangement direction are formed. In the battery module, a conductive module is assembled to each of the first electrode terminal group and the second electrode terminal group to form a battery pack. The conductive module for the first electrode terminal group includes a bus bar (hereinafter, referred to as “inter-cell bus bar”) that electrically connects a pair of electrode terminals adjacent to each other in the arrangement direction in the first electrode terminal group for each combination. In addition, the conductive module for the second electrode terminal group includes an inter-cell bus bar that electrically connects a pair of electrode terminals adjacent to each other in the arrangement direction in the second electrode terminal group for each combination. Further, in the battery module, an electrode terminal for a total positive electrode and an electrode terminal for a total negative electrode are allocated from the electrode terminals of any one of the first electrode terminal group and the second electrode terminal group. When the electrode terminal group to be assembled includes an electrode terminal for a total electrode (the electrode terminal for the total positive electrode or the electrode terminal for the total negative electrode), each conductive module also includes a bus bar (hereinafter, referred to as “total electrode bus bar”) for the electrode terminal. The conductive module includes a housing member that houses the inter-cell bus bar and also houses the total electrode bus bar if provided. For example, this type of conductive module is disclosed in Japanese Patent Application Laid-open No. JP 2018-200 753 A.

In a vehicle such as an electric vehicle, a battery pack electrically connecting total electrodes of a plurality of battery modules is mounted in order to extend a cruising distance. In such a battery pack, battery modules having different positions of electrode terminals for the total electrodes are mixed, or battery modules on which total electrode bus bars having different shapes are mounted are mixed depending on arrangement of the respective battery modules and the like. Therefore, in the battery pack, a conductive module having a large number of specifications different in a type of the bus bar, a shape of the housing member, and the like is required, and thus, there is a possibility of causing a cost increase.

### SUMMARY OF THE INVENTION

Therefore, an object of the present invention is to provide a battery pack and a conductive module component that can suppress an increase in cost.

In order to achieve the above mentioned object, a battery pack according to one aspect of the present invention includes a plurality of battery modules in which a plurality of battery cells including positive and negative electrode terminals are arranged, and one electrode terminal group including the electrode terminals on one side of the respective battery cells arranged in an arrangement direction and the other electrode terminal group including the electrode terminals on the other side of the respective battery cells arranged in the arrangement direction are provided; and a conductive module component forming a conductive module for each electrode terminal group of each battery module, wherein the conductive module component includes: an inter-cell bus bar that electrically connects a pair of the electrode terminals adjacent to each other in the arrangement direction in the electrode terminal group; a total electrode bus bar that is configured to be physically and electrically connected to the electrode terminal for a total electrode allocated among the electrode terminals of each electrode terminal group; an inter-cell bus bar housing member which is assembled to the electrode terminal group in which all the electrode terminals are allocated as combinations of a pair of the electrode terminals adjacent to each other in the arrangement direction and in which an inter-cell bus bar housing chamber for each inter-cell bus bar housing the inter-cell bus bar for each of all the combinations is provided; a common housing member which is assembled to the electrode terminal group with the total electrodes in which the electrode terminals at both ends among all the electrode terminals are allocated as the total positive and negative electrode bus bars, and a rest of the electrode terminals are allocated as combinations of a pair of electrode terminals adjacent to each other in the arrangement direction, and in which an inter-cell bus bar housing chamber for each inter-cell bus bar housing the inter-cell bus bar for each of all the combinations is provided; and a total electrode bus bar housing member which is assembled to the electrode terminal group with the total electrodes and in which a total electrode bus bar housing chamber housing the total electrode bus bar is formed, the inter-cell bus bar, the total electrode bus bar, the inter-cell bus bar housing member, the common housing member, and the total electrode bus bar housing member are provided in quantities corresponding to the electrode terminal groups and the electrode terminals of the electrode terminal groups, the common housing member is provided with coupling portions having the same shape at one end and the other end in the arrangement direction, and the total electrode bus bar housing member is provided with a coupled portion that is coupled to the one end of the common housing member by being assembled to the coupling portion at the one end of the common housing member, and coupled to the other end of the common housing member by being assembled to the coupling portion at the other end of the common housing member.

In order to achieve the above mentioned object, in a conductive module component according to another aspect of the present invention forming a conductive module for each of electrode terminal groups of a plurality of battery modules in which a plurality of battery cells including positive and negative electrode terminals are arranged, and one electrode terminal group including the electrode terminals on one side of the respective battery cells arranged in an arrangement direction and the other electrode terminal group including the electrode terminals on the other side of the respective battery cells arranged in the arrangement direction are provided, the conductive module component includes an inter-cell bus bar that electrically connects a pair of the electrode terminals adjacent to each other in the arrangement direction in the electrode terminal group; a total electrode bus bar that is configured to be physically and electrically connected to the electrode terminal for a total electrode allocated among the electrode terminals of each electrode terminal group; an inter-cell bus bar housing member which is assembled to the electrode terminal group in which all the electrode terminals are allocated as combinations of a pair of the electrode terminals adjacent to each other in the arrangement direction and in which an inter-cell bus bar housing chamber for each inter-cell bus bar housing the inter-cell bus bar for each of all the combinations is provided; a common housing member which is assembled to the electrode terminal group with the total electrodes in which the electrode terminals at both ends among all the electrode terminals are allocated as the total positive and negative electrode bus bars, and a rest of the electrode terminals are allocated as combinations of a pair of electrode terminals adjacent to each other in the arrangement direction, and in which an inter-cell bus bar housing chamber for each inter-cell bus bar housing the inter-cell bus bar for each of all the combinations is provided; and a total electrode bus bar housing member which is assembled to the electrode terminal group with the total electrodes and in which a total electrode bus bar housing chamber housing the total electrode bus bar is formed, wherein the inter-cell bus bar, the total electrode bus bar, the inter-cell bus bar housing member, the common housing member, and the total electrode bus bar housing member are provided in quantities corresponding to the electrode terminal groups and the electrode terminals of the electrode terminal groups, the common housing member is provided with coupling portions having the same shape at one end and the other end in the arrangement direction, and the total electrode bus bar housing member is provided with a coupled portion that is coupled to the one end of the common housing member by being assembled to the coupling portion at the one end of the common housing member, and coupled to the other end of the common housing member by being assembled to the coupling portion at the other end of the common housing member.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an explanatory view for describing an example of a battery pack and a conductive module component according to an embodiment;

FIG. 2 is a perspective view illustrating a battery module;

FIG. 3 is an explanatory view for describing a first conductive module;

FIG. 4 is an explanatory view for describing a second conductive module;

FIG. 5 is an explanatory view for describing a coupling portion and a coupled portion;

FIG. 6 is an explanatory view for describing a modified example of the battery pack and the conductive module component according to the embodiment;

FIG. 7 is an explanatory view for describing a third conductive module; and

FIG. 8 is an explanatory view for describing a fourth conductive module.

### DETAILED DESCRIPTION OF THE PREFERRED EMBODIMENTS

Hereinafter, an embodiment of a battery pack and a conductive module component according to the present invention will be described in detail with reference to the drawings. Note that the present invention is not limited by the embodiment.

### EMBODIMENT

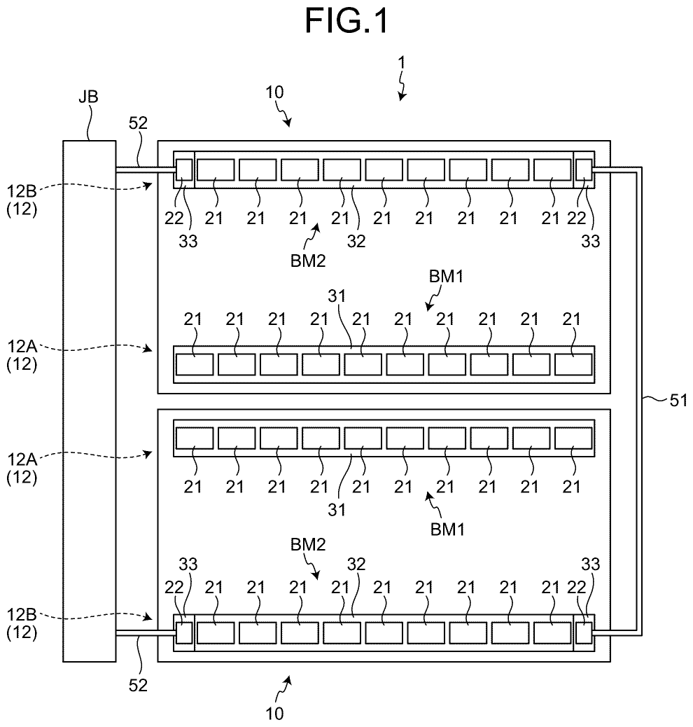

One of embodiments of a battery pack and a conductive module component according to the present invention will be described with reference to FIGS. 1 to 8.

The battery pack according to the present invention includes a plurality of battery modules. In the battery pack, each component included in the conductive module component is assembled to each battery module, and each battery cell is electrically connected for each battery module. In the battery pack, the respective battery modules are electrically connected by a conductive member or the like. The battery pack is mounted on, for example, a vehicle (a battery electric vehicle (BEV), a hybrid electric vehicle (HEV), or the like) including a rotary machine as a drive source, and is used for power supply to the rotary machine.

Reference numeral 1 in FIG. 1 represents an example of the battery pack according to the present embodiment. The battery pack 1 includes a pair of battery modules 10 (FIG. 1).

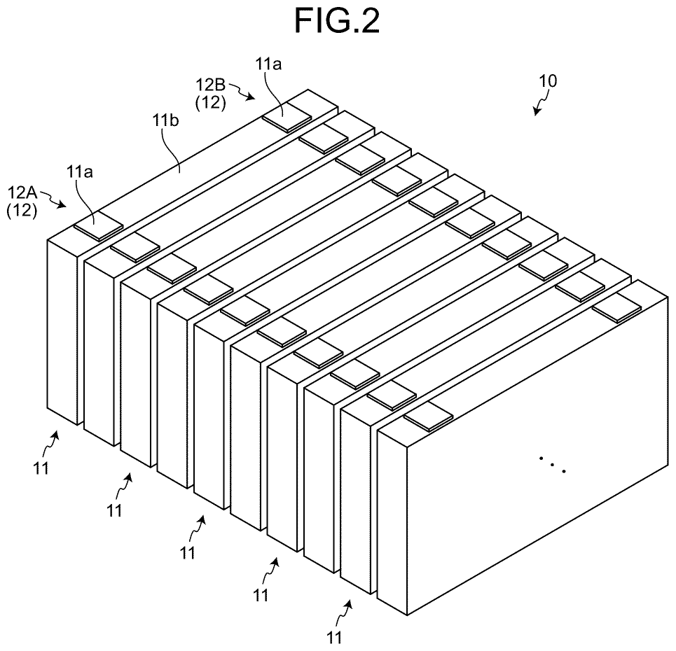

The battery module 10 includes a battery cell 11 provided with positive and negative electrode terminals 11a, and a plurality of battery cells 11 including the pair of electrode terminals 11a are arranged (FIG. 2). A type of the battery cell 11 is not limited, and may be, for example, a nickel-metal hydride battery or a lithium ion battery. In the battery cell 11 illustrated here, a cell body 11b is formed in a rectangular parallelepiped shape having six outer wall surfaces. In the battery module 10, the plurality of battery cells 11 are arranged in a row such that one outer wall surfaces of the cell bodies 11b face each other. The battery cell 11 illustrated here includes the positive and negative electrode terminals 11a on one outer wall surface of the cell body 11b that is different from the outer wall surface facing the outer wall surface of the cell body 11b of another battery cell 11 (FIG. 2). Therefore, in the battery module 10, one electrode terminal group (hereinafter, referred to as “first electrode terminal group”) 12A including the electrode terminals 11a on one side of the respective battery cells 11 arranged in an arrangement direction of the plurality of battery cells 11 and the other electrode terminal group (hereinafter, referred to as “second electrode terminal group”) 12B including the electrode terminals 11a on the other side of the respective battery cells 11 arranged in the arrangement direction are provided (FIG. 2). In the battery cell 11, one electrode terminal 11a and the other electrode terminal 11a may be provided on different outer wall surfaces of the cell body 11b. Hereinafter, the term “arrangement direction” refers to the arrangement direction of the plurality of battery cells 11.

The electrode terminal 11a may physically and electrically connect an inter-cell bus bar 21 and a total electrode bus bar 22 described below by welding, and in this case, for example, the electrode terminal 11a is formed in a flat plate shape. Further, the electrode terminal 11a may physically and electrically connect the inter-cell bus bar 21 and the total electrode bus bar 22 described below by screw fixing, and in this case, the electrode terminal 11a is formed in a pole shape including a male screw portion.

In the battery pack 1, the pair of battery modules 10 is arranged in a direction orthogonal to the arrangement direction of the plurality of battery cells 11 (FIG. 1).

The conductive module component includes the following various components for forming a conductive module for each electrode terminal group 12 (the first electrode terminal group 12A or the second electrode terminal group 12B) of each battery module 10. The conductive module is physically and electrically connected to one electrode terminal 11a in the electrode terminal group 12 or a pair of electrode terminals 11a adjacent to each other in the arrangement direction.

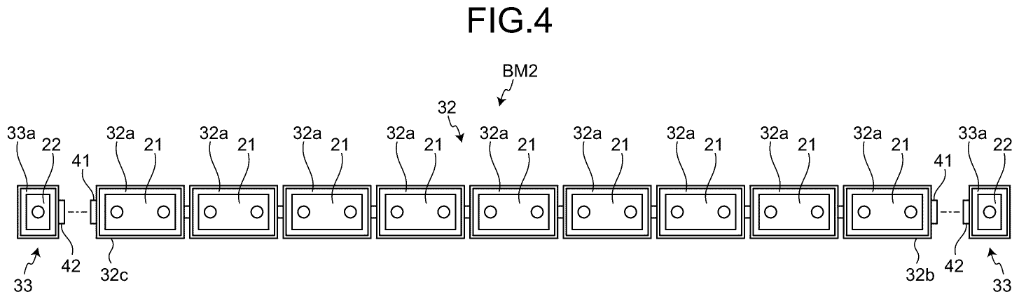

The conductive module component includes the inter-cell bus bar 21 that electrically connects a pair of electrode terminals 11a adjacent to each other in the arrangement direction in the electrode terminal group 12 (FIGS. 1, 3, and 4). Further, the conductive module component includes the total electrode bus bar 22 that can be physically and electrically connected to an electrode terminal 11a for a total electrode allocated from the respective electrode terminals 11a of the electrode terminal group 12 (FIGS. 1 and 4).

The inter-cell bus bar 21 and the total electrode bus bar 22 are plate-like conductive components made of metal, and for example, are press-molded using a metal plate as a base material. The inter-cell bus bar 21 and the total electrode bus bar 22 illustrated here are formed in a rectangular flat plate shape regardless of whether the inter-cell bus bar 21 and the total electrode bus bar 22 are welded or screwed and fixed to the electrode terminal 11a. In a case where the inter-cell bus bar 21 is screwed and fixed to two electrode terminals 11a having a pole shape, a through-hole through which the electrode terminal 11a is inserted is formed for each electrode terminal 11a. In a case where the total electrode bus bar 22 is screwed and fixed to one electrode terminal 11a having a pole shape, a through-hole through which the electrode terminal 11a is inserted is formed.

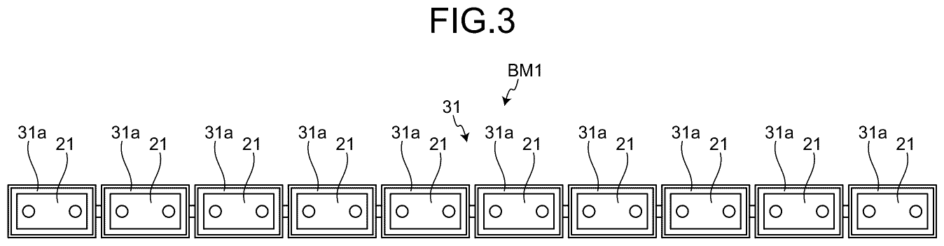

The conductive module component includes a first housing member (hereinafter, referred to as “inter-cell bus bar housing member”) 31 which is assembled to the electrode terminal group 12 in which all the electrode terminals 11a are allocated as combinations of a pair of electrode terminals 11a adjacent to each other in the arrangement direction, and an inter-cell bus bar housing chamber 31a for each inter-cell bus bar 21 housing the inter-cell bus bar 21 for each of all the combinations is provided (FIGS. 1 and 3). Further, the conductive module component includes a second housing member (hereinafter, referred to as “common housing member”) 32 which is assembled to the electrode terminal group 12 with the total electrodes in which the electrode terminals 11a at both ends among all the electrode terminals 11a are allocated as the total positive and negative electrode bus bars 22, and the rest of the electrode terminals 11a are allocated as combinations of a pair of electrode terminals 11a adjacent to each other in the arrangement direction, and in which an inter-cell bus bar housing chamber 32a for each inter-cell bus bar 21 housing the inter-cell bus bar 21 for each of all the combinations is provided (FIGS. 1 and 4). Furthermore, the conductive module component includes a third housing member (hereinafter, referred to as “total electrode bus bar housing member”) 33 which is assembled to the electrode terminal group 12 with the total electrodes and in which a total electrode bus bar housing chamber 33a housing the total electrode bus bar 22 is formed (FIGS. 1 and 4). The inter-cell bus bar housing member 31, the common housing member 32, and the total electrode bus bar housing member 33 are formed of an insulating material such as a synthetic resin.

In the inter-cell bus bar housing member 31, the inter-cell bus bar housing chambers 31a are arranged in the arrangement direction. The inter-cell bus bar housing chamber 31a is provided inside a rectangular tube-like portion having both ends opened. The inter-cell bus bar 21 is inserted into the inter-cell bus bar housing chamber 31a from an opening at one end with one flat surface facing the electrode terminal 11a. The inter-cell bus bar housing chamber 31a includes a bus bar locking portion (not illustrated) for using a side of an opening at the other end as a bottom portion in order to stop the inter-cell bus bar 21 in the chamber on the side of the opening at the other end. The bus bar locking portion is provided at a position that does not hinder connection between the inter-cell bus bar 21 and the electrode terminal 11a at the opening at the other end of the inter-cell bus bar housing chamber 31a. For example, the bus bar locking portion is provided in the opening at the other end so as to lock four corners of the inter-cell bus bar 21 on the side of the opening at the other end of the inter-cell bus bar housing chamber 31a.

In the common housing member 32, the inter-cell bus bar housing chambers 32a are arranged in the arrangement direction. The inter-cell bus bar housing chamber 32a has the same shape as the inter-cell bus bar housing chamber 31a of the inter-cell bus bar housing member 31, and includes a bus bar locking portion in the same manner as the inter-cell bus bar housing chamber 31a.

The total electrode bus bar housing chamber 33a of the total electrode bus bar housing member 33 is provided inside a rectangular tube-like portion having both ends opened. The total electrode bus bar 22 is inserted into the total electrode bus bar housing chamber 33a from an opening at one end with one flat surface facing the electrode terminal 11a. The total electrode bus bar housing chamber 33a includes the bus bar locking portion (not illustrated) for using a side of an opening at the other end as a bottom portion in order to stop the total electrode bus bar 22 in the chamber on the side of the opening at the other end. The bus bar locking portion is provided at a position that does not hinder connection between the total electrode bus bar 22 and the electrode terminal 11a at the opening at the other end of the total electrode bus bar housing chamber 33a. For example, the bus bar locking portion is provided in the opening at the other end so as to lock four corners of the total electrode bus bar 22 on the side of the opening at the other end of the total electrode bus bar housing chamber 33a.

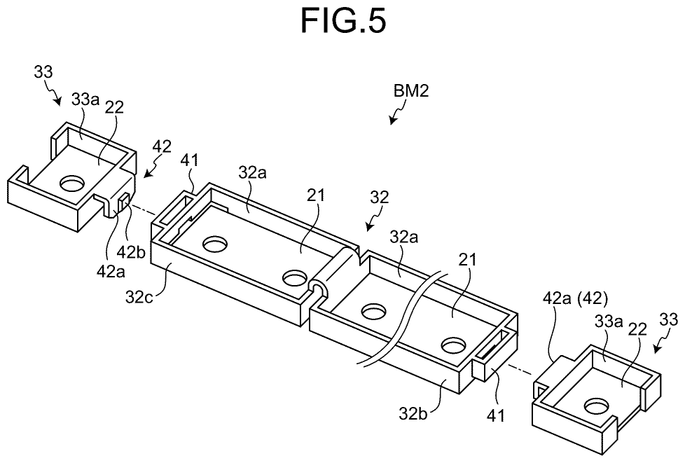

The total electrode bus bar housing members 33 are assembled to one end 32b and the other end 32c of the common housing member 32 in the arrangement direction (FIGS. 4 and 5). Therefore, the common housing member 32 is provided with coupling portions 41 having the same shape at the one end 32b and the other end 32c in the arrangement direction (FIGS. 4 and 5). The total electrode bus bar housing member 33 is provided with a coupled portion 42 that is coupled to the one end 32b of the common housing member 32 by being assembled to the coupling portion 41 at the one end 32b of the common housing member 32 and coupled to the other end 32c of the common housing member 32 by being assembled to the coupling portion 41 at the other end 32c of the common housing member 32 (FIGS. 4 and 5). For example, the coupling portion 41 is formed in a square tubular shape protruding from outer wall surfaces of the one end 32b and the other end 32c of the common housing member 32 and having both ends opened in a tubular axis direction of the inter-cell bus bar housing chamber 32a (a direction orthogonal to a flat surface of the inter-cell bus bar 21 in the inter-cell bus bar housing chamber 32a) (FIG. 5). The coupled portion 42 includes a cantilevered flexible piece portion 42a that protrudes from an outer wall surface of the total electrode bus bar housing member 33 and is inserted into the tubular coupling portion 41 from an opening at one end, and a claw portion 42b that protrudes from a free end of the flexible piece portion 42a coming out from an opening at the other end of the coupling portion 41 and is locked to a peripheral edge portion of the opening at the other end of the coupling portion 41 (FIG. 5).

The conductive module component includes the inter-cell bus bar 21, the total electrode bus bar 22, the inter-cell bus bar housing member 31, the common housing member 32, and the total electrode bus bar housing member 33 described above in quantities corresponding to the electrode terminal group 12 and the electrode terminals 11a of the electrode terminal group 12. Specific examples thereof will be described below.

As described above, in the battery pack 1 according to the present embodiment, the pair of battery modules 10 is arranged in a direction orthogonal to the arrangement direction of the plurality of battery cells 11. The conductive module component is assembled to each of the electrode terminal groups 12 of the pair of battery modules 10, and includes at least the inter-cell bus bar 21, the total electrode bus bar 22, the inter-cell bus bar housing member 31, the common housing member 32, and the total electrode bus bar housing member 33 in quantities adapted thereto. The conductive module component forms a first conductive module BM1 assembled to one electrode terminal group 12 (first electrode terminal group 12A) in each of the pair of battery modules 10 and a second conductive module BM2 assembled to the other electrode terminal group 12 (second electrode terminal group 12B) in each of the pair of battery modules 10 (FIGS. 1, 3, and 4).

In the battery pack 1, in the first electrode terminal group 12A, all the electrode terminals 11a are allocated as combinations of a pair of electrode terminals 11a adjacent to each other in the arrangement direction. Therefore, the first conductive module BM1 includes the inter-cell bus bar housing member 31 and the inter-cell bus bar 21 housed in each of the inter-cell bus bar housing chambers 31a of the inter-cell bus bar housing member 31 (FIGS. 1 and 3). That is, the first conductive module BM1 includes one inter-cell bus bar housing member 31 and a plurality of inter-cell bus bars 21 having the same shape and housed in the inter-cell bus bar housing member 31. The conductive module component forms the first conductive module BM1 assembled to the first electrode terminal group 12A of one battery module 10 and the first conductive module BM1 assembled to the first electrode terminal group 12A of the other battery module 10.

In the battery pack 1, the second electrode terminal group 12B is an electrode terminal group with the total electrodes in which the electrode terminals 11a at both ends among all the electrode terminals 11a are allocated as the total positive and negative electrode bus bars 22, and the rest of the electrode terminals 11a are allocated as combinations of a pair of electrode terminals 11a adjacent to each other in the arrangement direction. Therefore, the second conductive module BM2 includes the common housing member 32, the inter-cell bus bar 21 housed in each inter-cell bus bar housing chamber 32a of the common housing member 32, one total electrode bus bar housing member 33 coupled to the one end 32b of the common housing member 32, the total electrode bus bar 22 housed in the total electrode bus bar housing chamber 33a of one total electrode bus bar housing member 33, the other total electrode bus bar housing member 33 coupled to the other end 32c of the common housing member 32, and the total electrode bus bar 22 housed in the total electrode bus bar housing chamber 33a of the other total electrode bus bar housing member 33 (FIGS. 1 and 4). That is, the second conductive module BM2 includes one common housing member 32, a plurality of inter-cell bus bars 21 having the same shape and housed in the common housing member 32, two total electrode bus bar housing members 33 having the same shape, and two total electrode bus bars 22 having the same shape. The conductive module component forms the second conductive module BM2 assembled to the second electrode terminal group 12B of one battery module 10 and the second conductive module BM2 assembled to the second electrode terminal group 12B of the other battery module 10.

In the battery pack 1, the total electrode bus bars 22 housed in the respective one total electrode bus bar housing members 33 are electrically connected to each other by a conductive member 51 (FIG. 1). As the conductive member 51, for example, an electric wire of which one end is physically and electrically connected to one total electrode bus bar 22 and the other end is physically and electrically connected to the other total electrode bus bar 22, a flexible printed circuit board (FPC) provided with a conductor pattern of which one end is physically and electrically connected to one total electrode bus bar 22 and the other end is physically and electrically connected to the other total electrode bus bar 22, or the like is used.

In the battery pack 1, for example, the total electrode bus bar 22 housed in the other total electrode bus bar housing member 33 in one battery module 10 is connected to the electrode terminal 11a for a total positive electrode, and the total electrode bus bar 22 housed in the other total electrode bus bar housing member 33 in the other battery module 10 is connected to the electrode terminal 11a for a total negative electrode. In the battery pack 1, the total electrode bus bars 22 housed in the other total electrode bus bar housing members 33 are connected to an electrical junction box JB by conductive members 52, and power is supplied through the electrical junction box JB (FIG. 1). As the conductive member 52, for example, an electric wire, a flexible printed circuit board, or the like is used similarly to the conductive member 51.

In the battery pack 1 and the conductive module component described above, in a case where all the battery modules 10 include the same number of battery cells 11 and are the same as each other, the common housing member 32 is commonly used by the second electrode terminal groups 12B of the respective battery modules 10, and the combination of the total electrode bus bar housing member 33 and the total electrode bus bar 22 having a shape corresponding to the arrangement of the battery modules 10 is set for the second electrode terminal group 12B, so that it is not necessary to prepare a dedicated conductive module for each second electrode terminal group 12B of the battery module 10. Therefore, the battery pack 1 and the conductive module component according to the present embodiment can suppress an increase in cost of the housing member and the bus bar assembled to the second electrode terminal group 12B.

In addition, in the battery pack 1 and the conductive module component according to the present embodiment, since an application target of the common housing member 32 increases as the number of battery modules 10 increases, it is possible to achieve cost reduction by reducing depreciation cost of a molding die of the common housing member 32. In the battery pack 1 and the conductive module component according to the present embodiment, since the housing member is divided into the common housing member 32 and the total electrode bus bar housing member 33 for the second electrode terminal group 12B, it is possible to achieve cost reduction by downsizing the molding die as compared with a case where one housing member covers the second electrode terminal group 12B.

### Modified Example

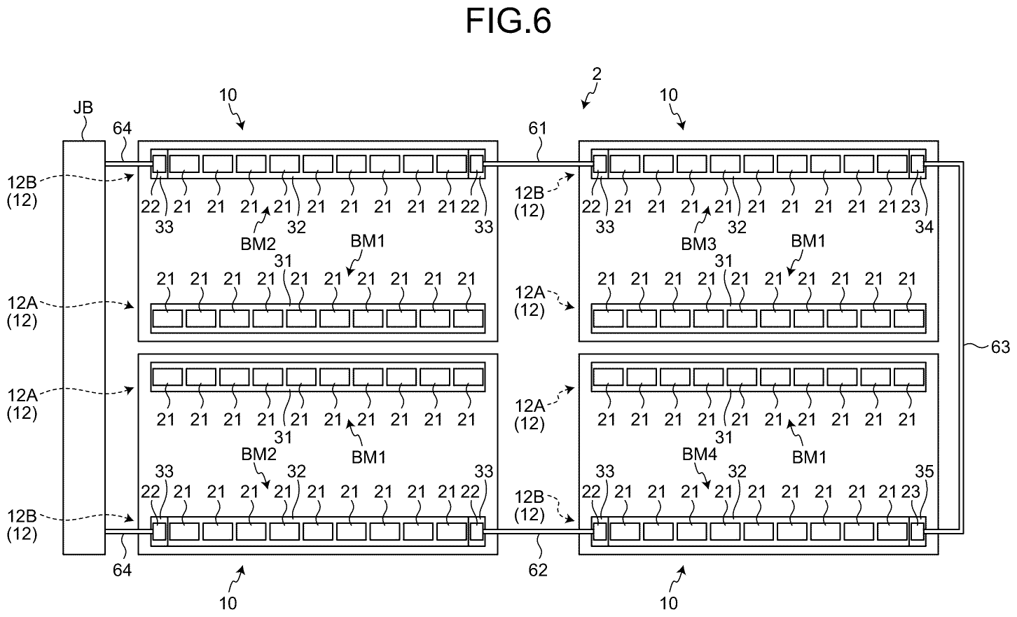

In the present modified example, a case where the conductive module component is applied to the following battery pack 2 will be described (FIG. 6).

The battery pack 2 includes another pair of battery modules 10 arranged on a side of the battery pack 1 (the pair of battery modules 10 arranged in a direction orthogonal to the arrangement direction) illustrated as an example of the above-described embodiment, the another pair of battery modules 10 being adjacent to the respective one total electrode bus bar housing members 33 in the arrangement direction (FIG. 6). Similarly to the pair of battery modules 10 of the battery pack 1, the another pair of battery modules 10 is arranged in a direction orthogonal to the arrangement direction. Hereinafter, the pair of battery modules 10 is referred to as a first battery module group, and the another pair of battery modules 10 is referred to as a second battery module group.

The conductive module component according to the present modified example is obtained by adding the following components to the conductive module component illustrated as an example of the embodiment. In the present modified example, a total electrode bus bar 22 of the conductive module component illustrated as an example of the embodiment is referred to as a first total electrode bus bar 22, and a total electrode bus bar housing member 33 of the conductive module component is referred to as a first total electrode bus bar housing member 33.

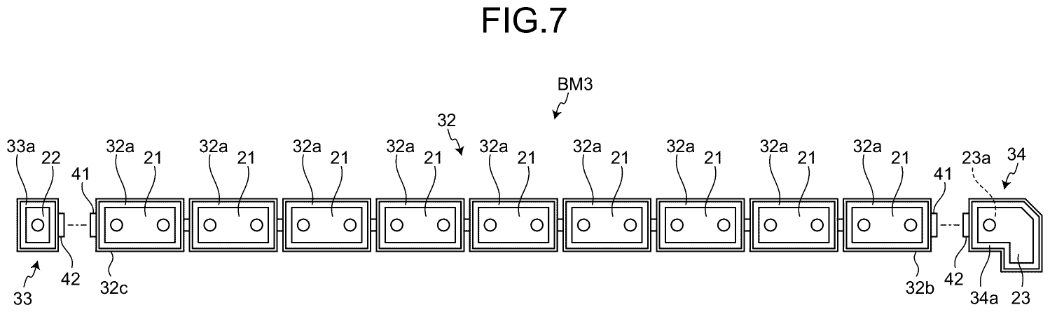

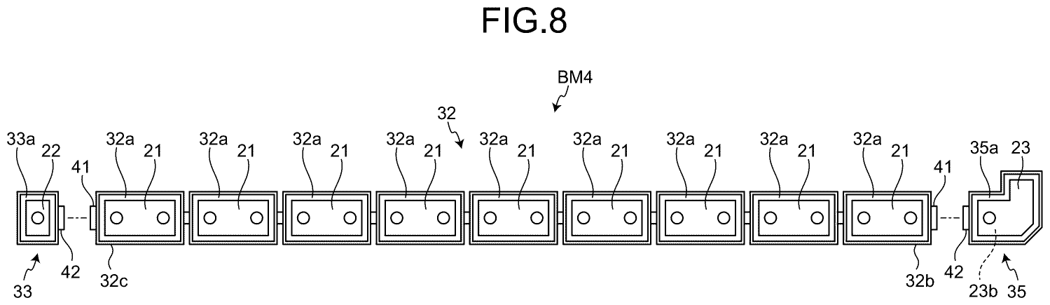

The conductive module component according to the present modified example includes a flat-plate-shaped second total electrode bus bar 23 that has a shape different from the first total electrode bus bar 22 and can be physically and electrically connected to an electrode terminal 11a for a total electrode (FIGS. 6 to 8). The conductive module component according to the present modified example includes a second total electrode bus bar housing member 34 in which a total electrode bus bar housing chamber 34a having a shape different from a total electrode bus bar housing chamber 33a of the first total electrode bus bar housing member 33 and housing the second total electrode bus bar 23 with one flat surface 23a facing a bottom portion is provided (FIGS. 6 and 7). The conductive module component according to the present modified example further includes a third total electrode bus bar housing member 35 in which a total electrode bus bar housing chamber 35a having a shape different from the total electrode bus bar housing chambers 33a and 34a of the first total electrode bus bar housing member 33 and the second total electrode bus bar housing member 34 and housing the second total electrode bus bar 23 with the other flat surface 23b facing a bottom portion is provided (FIGS. 6 and 8).

The second total electrode bus bar 23 illustrated here is formed in an L-shaped flat plate shape unlike the first total electrode bus bar 22 having a rectangular flat plate shape (FIGS. 7 and 8).

The second total electrode bus bar housing member 34 and the third total electrode bus bar housing member 35 are formed of an insulating material such as a synthetic resin.

The total electrode bus bar housing chamber 34a of the second total electrode bus bar housing member 34 is formed in an L shape capable of housing the L-shaped second total electrode bus bar 23 with the one flat surface 23a facing the bottom portion (FIG. 7). The second total electrode bus bar housing member 34 has a tubular portion which has openings at both ends and in which the L-shaped total electrode bus bar housing chamber 34a is formed. The second total electrode bus bar 23 is inserted into the total electrode bus bar housing chamber 34a from the opening at one end with the one flat surface 23a facing the electrode terminal 11a. The total electrode bus bar housing chamber 34a includes a bus bar locking portion (not illustrated) for using a side of the opening at the other end as the bottom portion in order to stop the second total electrode bus bar 23 in the chamber on the side of the opening at the other end. The bus bar locking portion is provided at a position that does not hinder connection between the second total electrode bus bar 23 and the electrode terminal 11a at the opening at the other end of the total electrode bus bar housing chamber 34a. For example, the bus bar locking portion is provided in the opening at the other end so as to lock corner portions at a plurality of positions in the second total electrode bus bar 23 on the side of the opening at the other end of the total electrode bus bar housing chamber 34a.

The total electrode bus bar housing chamber 35a of the third total electrode bus bar housing member 35 is formed in an L shape capable of housing the L-shaped second total electrode bus bar 23 with the other flat surface 23b facing the bottom portion (FIG. 8). The third total electrode bus bar housing member 35 has a tubular portion which has openings at both ends and in which the L-shaped total electrode bus bar housing chamber 35a is formed. The second total electrode bus bar 23 is inserted into the total electrode bus bar housing chamber 35a from the opening at one end with the other flat surface 23b facing the electrode terminal 11a. The total electrode bus bar housing chamber 35a includes a bus bar locking portion (not illustrated) for using a side of the opening at the other end as the bottom portion in order to stop the second total electrode bus bar 23 in the chamber on the side of the opening at the other end. The bus bar locking portion is provided at a position that does not hinder connection between the second total electrode bus bar 23 and the electrode terminal 11a at the opening at the other end of the total electrode bus bar housing chamber 35a. For example, the bus bar locking portion is provided in the opening at the other end so as to lock corner portions at a plurality of positions in the second total electrode bus bar 23 on the side of the opening at the other end of the total electrode bus bar housing chamber 35a.

The second total electrode bus bar housing member 34 and the third total electrode bus bar housing member 35 have the same coupled portion 42 as that of the first total electrode bus bar housing member 33 (FIGS. 7 and 8). Therefore, each of the second total electrode bus bar housing member 34 and the third total electrode bus bar housing member 35 can be assembled to one end 32b of a common housing member 32 via a coupling portion 41, or can be assembled to the other end 32c of the common housing member 32 via the coupling portion 41.

The conductive module component according to the present modified example forms a first conductive module BM1 assembled to each of one electrode terminal group 12 (first electrode terminal group 12A) in the first battery module group and one electrode terminal group 12 (first electrode terminal group 12A) in the second battery module group (FIG. 6). The first conductive module BM1 includes the same components as those exemplified above.

The conductive module component according to the present modified example forms a second conductive module BM2 assembled to the other electrode terminal group 12 (second electrode terminal group 12B) in the first battery module group (FIG. 6). The second conductive module BM2 includes the same components as those exemplified above.

The conductive module component according to the present modified example forms a third conductive module BM3 assembled to one of the other electrode terminal groups 12 (second electrode terminal groups 12B) in the second battery module group (FIGS. 6 and 7). The third conductive module BM3 includes the common housing member 32, an inter-cell bus bar 21 housed in each inter-cell bus bar housing chamber 32a of the common housing member 32, the first total electrode bus bar housing member 33 coupled to the other end 32c of the common housing member 32, the first total electrode bus bar 22 housed in the total electrode bus bar housing chamber 33a of the first total electrode bus bar housing member 33, the second total electrode bus bar housing member 34 coupled to the one end 32b of the common housing member 32, and the second total electrode bus bar 23 housed in the total electrode bus bar housing chamber 34a of the second total electrode bus bar housing member 34 (FIG. 7). That is, the third conductive module BM3 includes one common housing member 32, a plurality of inter-cell bus bars 21 having the same shape and housed in the common housing member 32, one first total electrode bus bar housing member 33, one first total electrode bus bar 22 housed in the first total electrode bus bar housing member 33, one second total electrode bus bar housing member 34, and one second total electrode bus bar 23 housed in the second total electrode bus bar housing member 34.

The conductive module component according to the present modified example forms a fourth conductive module BM4 assembled to another one of the other electrode terminal groups 12 (second electrode terminal groups 12B) in the second battery module group (FIGS. 6 and 8). The fourth conductive module BM4 includes the common housing member 32, the inter-cell bus bar 21 housed in each inter-cell bus bar housing chamber 32a of the common housing member 32, the first total electrode bus bar housing member 33 coupled to the other end 32c of the common housing member 32, the first total electrode bus bar 22 housed in the total electrode bus bar housing chamber 33a of the first total electrode bus bar housing member 33, the third total electrode bus bar housing member 35 coupled to the one end 32b of the common housing member 32, and the second total electrode bus bar 23 housed in the total electrode bus bar housing chamber 35a of the third total electrode bus bar housing member 35 (FIG. 8). That is, the fourth conductive module BM4 includes one common housing member 32, a plurality of inter-cell bus bars 21 having the same shape and housed in the common housing member 32, one first total electrode bus bar housing member 33, one first total electrode bus bar 22 housed in the first total electrode bus bar housing member 33, one third total electrode bus bar housing member 35, and one second total electrode bus bar 23 housed in the third total electrode bus bar housing member 35.

As described above, the conductive module component according to the present modified example includes two common housing members 32, a plurality of inter-cell bus bars 21 having the same shape and housed in the respective common housing members 32, two first total electrode bus bar housing members 33, two first total electrode bus bars 22 housed in the respective first total electrode bus bar housing members 33, one second total electrode bus bar housing member 34, one third total electrode bus bar housing member 35, and two second total electrode bus bars 23 housed in the second total electrode bus bar housing member 34 and the third total electrode bus bar housing member 35, and the third conductive module BM3 and the fourth conductive module BM4 are formed using these components.

In the battery pack 2, one battery module 10 of the first battery module group and one battery module 10 of the second battery module group are arranged in the arrangement direction (FIG. 6). In the battery pack 2, the electrode terminal 11a for the total electrode at one end of the second electrode terminal group 12B in one battery module 10 of the first battery module group and the electrode terminal 11a for the total electrode at the other end of the second electrode terminal group 12B in one battery module 10 of the second battery module group face each other in the arrangement direction. Therefore, in the battery pack 2, the first total electrode bus bar 22 connected to the electrode terminal 11a for the total electrode at one end and the first total electrode bus bar 22 connected to the electrode terminal 11a for the total electrode at the other end face each other in the arrangement direction (FIG. 6). In the battery pack 2, the pair of first total electrode bus bars 22 is electrically connected to each other by a first conductive member 61 (FIG. 6). As the first conductive member 61, for example, an electric wire, a flexible printed circuit board, or the like is used similarly to the conductive member 51 and the like exemplified above.

In the battery pack 2, the other battery module 10 of the first battery module group and the other battery module 10 of the second battery module group are arranged in the arrangement direction (FIG. 6). In the battery pack 2, the electrode terminal 11a for the total electrode at one end of the second electrode terminal group 12B in the other battery module 10 of the first battery module group and the electrode terminal 11a for the total electrode at the other end of the second electrode terminal group 12B in the other battery module 10 of the second battery module group face each other in the arrangement direction. Therefore, in the battery pack 2, the first total electrode bus bar 22 connected to the electrode terminal 11a for the total electrode at one end and the first total electrode bus bar 22 connected to the electrode terminal 11a for the total electrode at the other end face each other in the arrangement direction (FIG. 6). In the battery pack 2, the pair of first total electrode bus bars 22 is electrically connected to each other by a second conductive member 62 (FIG. 6). As the second conductive member 62, for example, an electric wire, a flexible printed circuit board, or the like is used similarly to the conductive member 51 and the like exemplified above.

In the battery pack 2, the second total electrode bus bars 23 housed in the second total electrode bus bar housing member 34 and the third total electrode bus bar housing member 35 are electrically connected to each other by a third conductive member 63 (FIG. 6). As the third conductive member 63, for example, an electric wire, a flexible printed circuit board, or the like is used similarly to the conductive member 51 and the like exemplified above.

In the battery pack 2, for example, the first total electrode bus bar 22 housed in the other first total electrode bus bar housing member 33 in one battery module 10 of the first battery module group is connected to the electrode terminal 11a for a total positive electrode, and the first total electrode bus bar 22 housed in the other first total electrode bus bar housing member 33 in the other battery module 10 of the first battery module group is connected to the electrode terminal 11a for a total negative electrode. In the battery pack 2, the first total electrode bus bars 22 housed in the other first total electrode bus bar housing members 33 are connected to an electrical junction box JB by fourth conductive members 64, and power is supplied through the electrical junction box JB (FIG. 6). As the fourth conductive member 64, for example, an electric wire, a flexible printed circuit board, or the like is used similarly to the conductive member 51 exemplified above.

In the battery pack 2 and the conductive module component described above, in a case where all the battery modules 10 include the same number of battery cells 11 and are the same as each other, the common housing member 32 can be commonly used by the second electrode terminal groups 12B of the respective battery modules 10. In the battery pack 2 and the conductive module component, a combination of the first total electrode bus bar housing member 33 and the first total electrode bus bar 22 can be commonly used at four positions in the respective second electrode terminal groups 12B of the first battery module group and two positions in the respective second electrode terminal groups 12B of the second battery module group. Further, in the battery pack 2 and the conductive module component, the second total electrode bus bar 23 can be commonly used at two positions in the respective second electrode terminal groups 12B of the second battery module group. Therefore, in the battery pack 2 and the conductive module component, it is not necessary to prepare a dedicated conductive module for each of the second electrode terminal groups 12B of all the battery modules 10. Therefore, the battery pack 2 and the conductive module component according to the present modified example can suppress an increase in cost of the housing member and the bus bar assembled to the second electrode terminal group 12B.

In addition, in the battery pack 2 and the conductive module component according to the present modified example, since an application target of the common housing member 32 increases as the number of battery modules 10 increases, it is possible to achieve cost reduction by reducing depreciation cost of a molding die of the common housing member 32. In addition, in the battery pack 2 and the conductive module component according to the present modified example, the housing member is divided into the common housing member 32 and the first total electrode bus bar housing member 33 for the second electrode terminal group 12B, the housing member is divided into the common housing member 32, the first total electrode bus bar housing member 33, and the second total electrode bus bar housing member 34, and the housing member is divided into the common housing member 32, the first total electrode bus bar housing member 33, and the third total electrode bus bar housing member 35, so that it is possible to achieve cost reduction by downsizing the molding die as compared with a case where one housing member covers the second electrode terminal group 12B.

In the battery pack and the conductive module component according to the present embodiment, for example, in a case where all the battery modules include the same number of battery cells and are the same as each other, the common housing member is commonly used by the other electrode terminal groups of the respective battery modules, and a combination of the total electrode bus bar housing member and the total electrode bus bar having a shape corresponding to the arrangement of the battery modules is set for the electrode terminal group, so that it is not necessary to prepare a dedicated conductive module for each other electrode terminal group of the battery module. Therefore, the battery pack and the conductive module component according to the present embodiment can suppress an increase in cost of the housing member and the bus bar assembled to the other electrode terminal group.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A battery pack comprising:
a plurality of battery modules in which a plurality of battery cells including positive and negative electrode terminals are arranged, and one electrode terminal group including the electrode terminals on one side of the respective battery cells arranged in an arrangement direction and the other electrode terminal group including the electrode terminals on the other side of the respective battery cells arranged in the arrangement direction are provided; and
a conductive module component forming a conductive module for each electrode terminal group of each battery module, wherein
the conductive module component includes:
an inter-cell bus bar that electrically connects a pair of the electrode terminals adjacent to each other in the arrangement direction in the electrode terminal group;
a total electrode bus bar that is configured to be physically and electrically connected to the electrode terminal for a total electrode allocated among the electrode terminals of each electrode terminal group;
an inter-cell bus bar housing member which is assembled to the electrode terminal group in which all the electrode terminals are allocated as combinations of a pair of the electrode terminals adjacent to each other in the arrangement direction and in which an inter-cell bus bar housing chamber for each inter-cell bus bar housing the inter-cell bus bar for each of all the combinations is provided;
a common housing member which is assembled to the electrode terminal group with the total electrodes in which the electrode terminals at both ends among all the electrode terminals are allocated as the total positive and negative electrode bus bars, and a rest of the electrode terminals are allocated as combinations of a pair of electrode terminals adjacent to each other in the arrangement direction, and in which an inter-cell bus bar housing chamber for each inter-cell bus bar housing the inter-cell bus bar for each of all the combinations is provided; and
a total electrode bus bar housing member which is assembled to the electrode terminal group with the total electrodes and in which a total electrode bus bar housing chamber housing the total electrode bus bar is formed,
the inter-cell bus bar, the total electrode bus bar, the inter-cell bus bar housing member, the common housing member, and the total electrode bus bar housing member are provided in quantities corresponding to the electrode terminal groups and the electrode terminals of the electrode terminal groups,
the common housing member is provided with coupling portions having the same shape at one end and the other end in the arrangement direction, and
the total electrode bus bar housing member is provided with a coupled portion that is coupled to the one end of the common housing member by being assembled to the coupling portion at the one end of the common housing member, and coupled to the other end of the common housing member by being assembled to the coupling portion at the other end of the common housing member.

2. The battery pack according to claim 1, further comprising:
a pair of the battery modules arranged in a direction orthogonal to the arrangement direction, wherein
a first conductive module including the inter-cell bus bar housing member and the inter-cell bus bar housed in the inter-cell bus bar housing chamber of each of the inter-cell bus bar housing members is assembled to the one electrode terminal group in each of the pair of battery modules, and
a second conductive module including the common housing member, the inter-cell bus bar housed in each inter-cell bus bar housing chamber of the common housing member, one total electrode bus bar housing member coupled to the one end of the common housing member, the total electrode bus bar housed in the total electrode bus bar housing chamber of the one total electrode bus bar housing member, the other total electrode bus bar housing member coupled to the other end of the common housing member, and the total electrode bus bar housed in the total electrode bus bar housing chamber of the other total electrode bus bar housing member is assembled to the other electrode terminal group in each of the pair of battery modules.

3. The battery pack according to claim 2, wherein
the total electrode bus bars housed in the respective one total electrode bus bar housing members are electrically connected to each other by a conductive member.

4. The battery pack according to claim 2, wherein
the conductive module component includes:
a flat-plate-shaped second total electrode bus bar having a shape different from the total electrode bus bar as a first total electrode bus bar and configured to be physically and electrically connected to the electrode terminal for the total electrode;
a second total electrode bus bar housing member in which a total electrode bus bar housing chamber having a shape different from the total electrode bus bar housing chamber of the total electrode bus bar housing member as a first total electrode bus bar housing member and housing the second total electrode bus bar with one flat surface facing a bottom portion is provided; and
a third total electrode bus bar housing member in which a total electrode bus bar housing chamber having a shape different from the total electrode bus bar housing chambers of the first total electrode bus bar housing member and the second total electrode bus bar housing member and housing the second total electrode bus bar with the other flat surface facing a bottom portion is provided,
the second total electrode bus bar housing member and the third total electrode bus bar housing member have the coupled portion,
the battery pack further comprises another pair of battery modules arranged on a side of the pair of battery modules, the another pair of battery modules being adjacent to the respective first total electrode bus bar housing members on one side in the arrangement direction,
the first conductive module is assembled to the one electrode terminal group in each of the another pair of battery modules,
a third conductive module including the common housing member, the inter-cell bus bar housed in each inter-cell bus bar housing chamber of the common housing member, the first total electrode bus bar housing member coupled to the other end of the common housing member, the first total electrode bus bar housed in the total electrode bus bar housing chamber of the first total electrode bus bar housing member, the second total electrode bus bar housing member coupled to the one end of the common housing member, and the second total electrode bus bar housed in the total electrode bus bar housing chamber of the second total electrode bus bar housing member is assembled to one of the other electrode terminal groups of the another pair of the battery modules, and
a fourth conductive module including the common housing member, the inter-cell bus bar housed in each inter-cell bus bar housing chamber of the common housing member, the first total electrode bus bar housing member coupled to the other end of the common housing member, the first total electrode bus bar housed in the total electrode bus bar housing chamber of the first total electrode bus bar housing member, the third total electrode bus bar housing member coupled to the one end of the common housing member, and the second total electrode bus bar housed in the total electrode bus bar housing chamber of the third total electrode bus bar housing member is assembled to another one of the other electrode terminal groups of the another pair of battery modules.

5. The battery pack according to claim 4, wherein
a pair of the first total electrode bus bars facing each other in the arrangement direction on one side are electrically connected to each other by a first conductive member, a pair of the first total electrode bus bars facing each other in the arrangement direction on the other side are electrically connected to each other by a second conductive member, and the second total electrode bus bars housed in the second total electrode bus bar housing member and the third total electrode bus bar housing member are electrically connected to each other by a third conductive member.

6. A conductive module component forming a conductive module for each of electrode terminal groups of a plurality of battery modules in which a plurality of battery cells including positive and negative electrode terminals are arranged, and one electrode terminal group including the electrode terminals on one side of the respective battery cells arranged in an arrangement direction and the other electrode terminal group including the electrode terminals on the other side of the respective battery cells arranged in the arrangement direction are provided, the conductive module component comprising:
an inter-cell bus bar that electrically connects a pair of the electrode terminals adjacent to each other in the arrangement direction in the electrode terminal group;
a total electrode bus bar that is configured to be physically and electrically connected to the electrode terminal for a total electrode allocated among the electrode terminals of each electrode terminal group;
an inter-cell bus bar housing member which is assembled to the electrode terminal group in which all the electrode terminals are allocated as combinations of a pair of the electrode terminals adjacent to each other in the arrangement direction and in which an inter-cell bus bar housing chamber for each inter-cell bus bar housing the inter-cell bus bar for each of all the combinations is provided;
a common housing member which is assembled to the electrode terminal group with the total electrodes in which the electrode terminals at both ends among all the electrode terminals are allocated as the total positive and negative electrode bus bars, and a rest of the electrode terminals are allocated as combinations of a pair of electrode terminals adjacent to each other in the arrangement direction, and in which an inter-cell bus bar housing chamber for each inter-cell bus bar housing the inter-cell bus bar for each of all the combinations is provided; and
a total electrode bus bar housing member which is assembled to the electrode terminal group with the total electrodes and in which a total electrode bus bar housing chamber housing the total electrode bus bar is formed, wherein
the inter-cell bus bar, the total electrode bus bar, the inter-cell bus bar housing member, the common housing member, and the total electrode bus bar housing member are provided in quantities corresponding to the electrode terminal groups and the electrode terminals of the electrode terminal groups,
the common housing member is provided with coupling portions having the same shape at one end and the other end in the arrangement direction, and
the total electrode bus bar housing member is provided with a coupled portion that is coupled to the one end of the common housing member by being assembled to the coupling portion at the one end of the common housing member, and coupled to the other end of the common housing member by being assembled to the coupling portion at the other end of the common housing member.
